(19) United States
(12) Patent Application Publication
(10) Pub. No.: US 2007/0113257 A1
(43) Pub. Date: May 17, 2007

(54) Reception device

(76) Inventor: Takahiro Takemoto, Hiroshima (JP)

Correspondence Address: WENDEROTH, LIND & PONACK L.L.P., 2033 K. STREET, NW, SUITE 800, WASHINGTON, DC, 20006, US

(21) Appl. No.: 10/581,057

(22) PCT Filed: Dec. 22, 2004
(86) PCT No.: PCT/JP04/19695

§ 371 Date: May 30, 2006

(30) Foreign Application Priority Data
Dec. 22, 2003 (JP) 2003-424194

(51) Int. Cl. H04N 7/173; G06F 3/00; G06F 13/00; H04N 5/50; H04N 7/16; H04N 5/445

(52) U.S. Cl. 725/131; 725/38; 348/731; 725/100; 725/135

(57) ABSTRACT

To provide a reception device for receiving a broadcast wave, selecting any of a commercial stream and a program stream that are modulated in the broadcast wave, and outputting the selected stream. The reception device includes an acceptance unit which accepts a channel operation by a user, and a switch unit which, when the acceptance unit accepts the channel operation, selects the commercial stream before the program stream, as the stream to be output.

### TECHNICAL FIELD

The present invention relates to a reception device for receiving a broadcast wave which carries multiplexed streams.

### BACKGROUND ART

Digitization of broadcasting has been showing rapid progress in recent years. In digital broadcasting, the MPEG2-TS standard is used for multiplexing video, audio, and data for transmission. According to the MPEG2-TS standard, bit strings to be transmitted are divided by a predetermined length with the addition of a header, to form 188-byte transmission data units called TS packets.

Digital broadcasting offers pay programs to users who pay for viewing in units of programs or channels. Digital broadcasting also offers free programs to users based on advertisement rates by inserting sponsors' commercials within or between programs, like conventional analog broadcasting. Naturally, the sponsors wish their commercials to be seen by as many users as possible.

However, a sponsor cannot know when a user starts viewing a television broadcast. Suppose a commercial precedes a program. In this case, if the user starts viewing at the beginning of the commercial, he or she will watch the whole commercial. However, if the user starts viewing during the commercial or at the beginning of the program, a commercial viewing time of the user shortens. Also, the user may switch to another channel during the commercial inserted within the program. This also shortens the commercial viewing time. In the worst case, the user may not view the commercial at all. This makes the sponsor less eager to invest in broadcasting.

### DISCLOSURE OF THE INVENTION

The present invention was conceived in view of the above problem, and has an object of providing a reception device which ensures a commercial viewing time of a user.

The stated object can be achieved by a reception device for receiving a broadcast wave, selecting any of a commercial stream and a program stream that are modulated in the broadcast wave, and outputting the selected stream, including: an acceptance unit operable to accept a channel operation by a user; and a switch unit operable to, when the acceptance unit accepts the channel operation, select the commercial stream before the program stream, as the stream to be output.

According to the above construction, when the user performs a channel operation, the commercial stream is selected before the program stream. This ensures the commercial viewing time of the user. For instance, when the user requests turn-on of the reception device or channel switching, first the commercial stream is mandatorily selected, to make the user view a commercial. This increases the advertising effectiveness, and as a result attracts sponsors.

Here, the reception device may further include a first judgment unit operable to judge whether an end time of one of a plurality of commercials which are included in the commercial stream has come, the commercial stream also including time information showing an end time of each of the plurality of commercials, wherein the switch unit switches from the commercial stream to the program stream when the first judgment unit judges that the end time of the commercial has come.

According to the above construction, the commercial stream is switched to the program stream at the end time of one of the plurality of commercials. For instance, when the user requests turn-on of the reception device or channel switching, first the commercial stream is mandatorily selected until the end time of the commercial. This makes the user view the commercial to the end, before viewing the program.

Here, the reception device may further include a second judgment unit operable to judge whether an end time of one of a plurality of program segments which are included in the program stream has come, the program stream also including time information showing an end time of each of the plurality of program segments, wherein the switch unit switches from the program stream back to the commercial stream when the second judgment unit judges that the end time of the program segment has come.

According to the above construction, the commercial stream is selected again after the program stream. This increases the commercial viewing time.

Here, the switch unit may repeatedly switch from the commercial stream to the program stream and back to the commercial stream, so long as a predetermined condition is met.

According to the above construction, the mandatory selection of the commercial stream is repeated to increase the commercial viewing time.

Here, the reception device may further include a third judgment unit operable to judge whether the acceptance unit accepts a commercial viewing operation by the user before the end time of the program segment, wherein when the third judgment unit judges that the acceptance unit accepts the commercial viewing operation before the end time of the program segment, the switch unit switches from the program stream back to the commercial stream without waiting for the end time of the program segment.

A commercial tends to be inserted at an exciting part of a program, to raise the viewing rating of the commercial. This often annoys users. According to the above construction, however, the user can view the commercial when he or she likes. This allows the user to enjoy the program without discomfort.

Here, the reception device may further include a display unit operable to display a character string indicating one of the plurality of commercials that corresponds to a current time, wherein the acceptance unit accepts the commercial viewing operation of requesting to view the commercial indicated by the displayed character string.

According to the above construction, the character string indicating the commercial that corresponds in time to the program segment is superimposed on the image of the program segment, to inform the user of the commercial while watching the program. If the user becomes interested in the commercial, he or she can switch to the commercial stream.

Here, a synopsis stream may be modulated in the broadcast wave together with the commercial stream and the program stream, wherein the switch unit selects the synopsis stream after the commercial stream and before the program stream, for a predetermined time period.

According to the above construction, even when the user starts viewing the program from a midpoint, he or she can understand the preceding contents of the program through a synopsis image.

Here, the synopsis stream may include a plurality of synopses, wherein the switch unit selects the synopsis stream to output one of the plurality of synopses that corresponds to a current time.

According to the above construction, the synopsis from the beginning of the program up to the current time is provided to the user, so that the user can understand the preceding contents of the program.

Here, the reception device may further include a composite unit operable to, when the switch unit switches from the program stream back to the commercial stream, display a composite image in which an image of the commercial indicated by the displayed character string is scaled down and superimposed on an image of the program segment.

According to the above construction, the commercial image is superimposed on the program image as a picture-in-picture. This enables the user to watch the commercial while watching the program.

Here, each of the program stream and the commercial stream may include a bonus image at an end portion, wherein any of the program stream and the commercial stream includes information showing a selection criterion for each bonus image, and the reception device further includes: a measurement unit operable to measure a total time during which one of the program stream and the commercial stream is selected; and an output unit operable to, when a current time reaches the end portion of the program stream, output a bonus image corresponding to a selection criterion that is satisfied by the total time measured by the measurement unit.

According to the above construction, a different bonus image is offered depending on the program viewing time or the commercial viewing time. This has the effect of discouraging the user from switching to another channel.

### BRIEF DESCRIPTION OF DRAWINGS

FIG. 1 is a functional block diagram of a reception device to which the first embodiment of the present invention relates.

FIG. 2 shows a structure of stream switching information.

FIG. 3 shows a structure of stream switching information.

FIG. 4 is a flowchart of an operation of the reception device.

FIG. 5 is a flowchart of a commercial stream selection operation shown in FIG. 4.

FIG. 6 is a flowchart of a synopsis stream selection operation shown in FIG. 4.

FIG. 7 shows a specific example of stream switching information.

FIG. 8 shows a specific example of stream switching information.

FIG. 9 shows example contents of bonus image selection information.

FIG. 10 shows a specific example of switching from one stream to another.

FIG. 11 shows example contents of a viewing history table in the second embodiment of the present invention.

FIG. 12 shows a specific example of stream switching information in the third embodiment of the present invention.

FIG. 13 shows a specific example of stream switching information in the third embodiment.

FIG. 14 shows a specific example of switching from one stream to another.

FIG. 15 is a functional block diagram of a reception device to which the fourth and fifth embodiments of the present invention relate.

FIG. 16 shows an example display in which a subtitle indicating a commercial is superimposed on a program image.

FIG. 17 is a flowchart of an operation of the reception device in the fourth embodiment.

FIG. 18 shows an example display in which a commercial image is superimposed on a program image as a picture-in-picture, in the fifth embodiment of the present invention.

FIG. 19 is a flowchart of a commercial stream selection operation in the fifth embodiment.

FIG. 20 shows a specific example of stream switching information in the sixth embodiment of the present invention.

FIG. 21 shows a specific example of stream switching information in the sixth embodiment.

FIG. 22 shows a specific example of switching from one stream to another.

FIG. 23 shows a specific example of switching from one stream to another, in the seventh embodiment of the present invention.

### BEST MODE FOR CARRYING OUT THE INVENTION

### First Embodiment

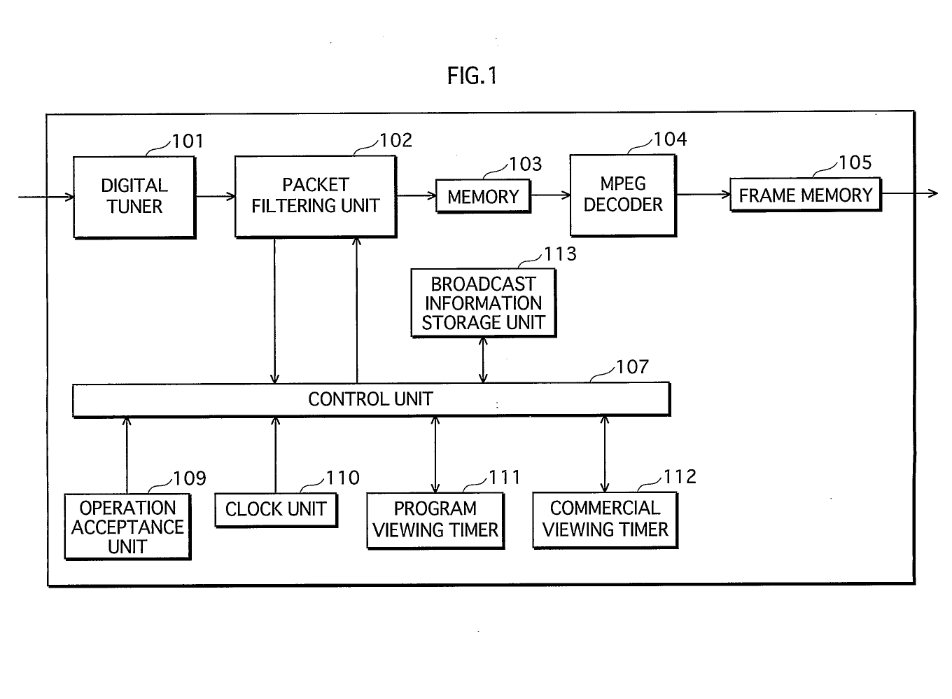

The following describes a reception device to which the first embodiment of the present invention relates, with reference to drawings. FIG. 1 is a functional block diagram of the reception device. In the drawing, the reception device includes a digital tuner 101, a packet filtering unit 102, a memory 103, an MPEG decoder 104, a frame memory 105, a control unit 107, an operation acceptance unit 109, a clock unit 110, a program viewing timer 111, a commercial viewing timer 112, and a broadcast information storage unit 113.

The reception device is actually realized by a computer system that includes a microprocessor, a ROM, a RAM, a hard disk unit, and the like. A computer-readable program is stored on the ROM or the hard disk unit. The functions of the reception device are realized by the microprocessor operating in accordance with this computer-readable program.

Each construction element of the reception device is explained below.

The digital tuner 101 receives a broadcast wave carrying multiplexed streams, and demodulates it. Each channel is constituted by a plurality of streams. In this embodiment, each channel is constituted by a program stream for broadcasting a whole program, a synopsis stream for broadcasting synopses of segments of the program that each have a predetermined length, and a commercial stream for broadcasting commercials. The program stream, the synopsis stream, and the commercial stream are synchronized with each other. Also, the synopses in the synopsis stream and the commercials in the commercial stream are synchronized with each other.

The packet filtering unit 102 receives a TS packet from the digital tuner 101, and outputs a PMT (Program Map Table) contained in the TS packet to the control unit 107. Also, the packet filtering unit 102 receives a PID (Packet Identifier) from the control unit 107, and outputs a PES (Packetized Elementary Stream) packet stored in payloads of TS packets having the received PID to the memory 103.

The memory 103 stores the PES packet received from the packet filtering unit 102, and outputs an elementary stream to the MPEG decoder 104.

The MPEG decoder 104 decodes the elementary stream received from the memory 103, to obtain a video signal and an audio signal.

The frame memory 105 is a dedicated memory for storing one frame (one screen).

The control unit 107 receives the PMT from the packet filtering unit 102, and outputs the PID specifying the stream to be selected to the packet filtering unit 102. The PMT stores PIDs of audio, video, and the like associated with a service. Each of these PIDs identifies the type of TS packet. The control unit 107 references the PMT, to extract TS packets having the same PID and obtain the original stream from these TS packets. For example, to select a program stream, the control unit 107 outputs a PID which identifies the program stream to the packet filtering unit 102. The PMT can also carry descriptive information about a broadcast and streams included in the broadcast, in the form of small data units such as sections or descriptors. In this specification, the term “broadcast” is used to mean a program and a commercial which accompanies the program. Also, the control unit 107 acquires SI (service information), and outputs the SI to the broadcast information storage unit 113.

The operation acceptance unit 109 accepts a user operation of requesting to turn on the reception device, to switch to another channel, to view a commercial, and so on.

The clock unit 110 indicates a current time, and outputs information showing the current time to the control unit 107.

The program viewing timer 111 indicates a time during which a program stream is selected. In this embodiment, the program viewing timer 111 is reset whenever channel switching is made.

The commercial viewing timer 112 indicates a time during which a commercial stream is selected. The commercial viewing timer 112 is initially set to a required commercial viewing time, and decreases with commercial viewing by the user. Once the commercial viewing timer 112 has reached 0, mandatory selection of the commercial stream is no longer performed.

Note here that a bonus image to be selected after the end of the program varies depending on the program viewing time or commercial viewing time of the user. Bonus images include, for example, bloopers, deleted scenes, featurettes, and gift announcements.

The broadcast information storage unit 113 stores the SI received from the control unit 107. The SI is information about the broadcast, such as stream switching information, a program name, and a program description.

As one example, the stream switching information shows a channel, a broadcast start time, a program stream ID, bonus image selection information, a program start time, a program end time, a bonus image start time, a bonus image end time, a commercial stream ID, a required commercial viewing time, a mandatory commercial selection start time, a mandatory commercial selection end time, a commercial start time, a commercial end time, a synopsis stream ID, a synopsis start time, and a synopsis end time. The bonus image selection information is used when selecting a bonus image depending on the program viewing time or commercial viewing time of the user. The required commercial viewing time is a time period for which the commercial stream is to be selected. The required commercial viewing time is set for each individual broadcast. The required commercial viewing time covers both a time during which the commercial stream is mandatorily selected and a time during which the commercial stream is voluntarily selected by the user. The mandatory commercial selection start time and the mandatory commercial selection end time are set by a broadcast station. The mandatory commercial selection start time is a time at which the commercial stream is mandatorily selected, even during selection of the program stream. The mandatory commercial selection end time is a time at which the mandatory selection of the commercial stream is to end. Which is to say, the commercial stream is switched back to the program stream at the mandatory commercial selection end time.

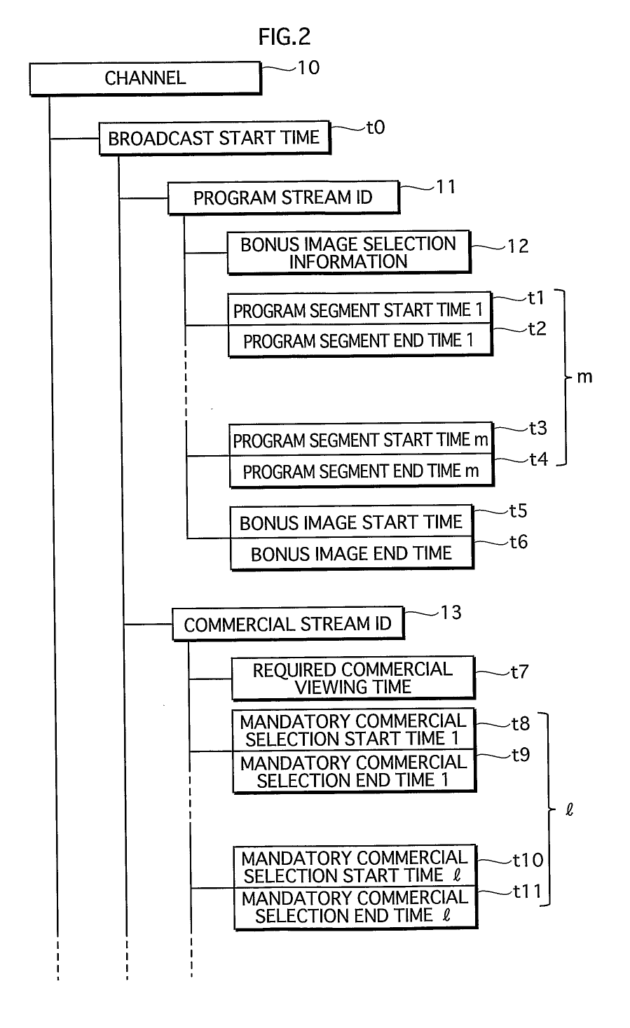

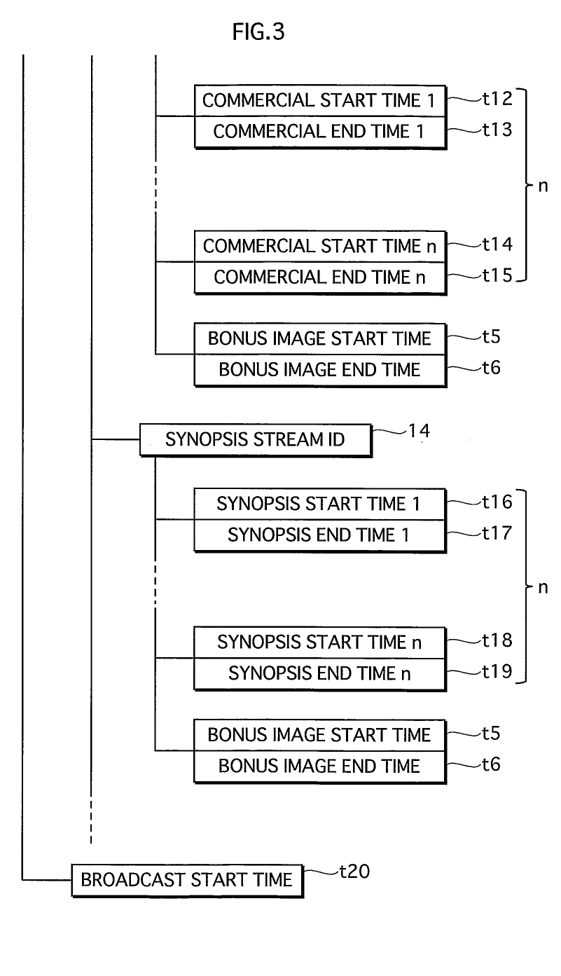

FIGS. 2 and 3 show a structure of such stream switching information. Stream switching information is set for each individual broadcast of each channel. In the drawings, N broadcast start times t0 to t20 are provided below a channel 10. A program stream ID, a commercial stream ID, and a synopsis stream ID are provided below each of the N broadcast start times t0 to t20. For example, a program stream ID 11, a commercial stream ID 13, and a synopsis stream ID 14 are provided below the broadcast start time to.

Bonus image selection information 12, m program segment start times 1 t1 to m t3, m program segment end times 1 t2 to m t4, a bonus image start time t5, and a bonus image end time t6 are provided below the program stream ID 11. Meanwhile, a required commercial viewing time t7, 1 mandatory commercial selection start times 1 t8 to 1 t10, 1 mandatory commercial selection end times 1 t9 to 1 t11, n commercial start times 1 t12 to n t14, n commercial end times 1 t13 to n t15, the bonus image start time t5, and the bonus image end time t6 are provided below the commercial stream ID 13. Further, n synopsis start times 1 t16 to n t18, n synopsis end times 1 t17 to n t19, the bonus image start time t5, and the bonus image end time t6 are provided below the synopsis stream ID 14.

The following describes an operation of the reception device having the above construction.

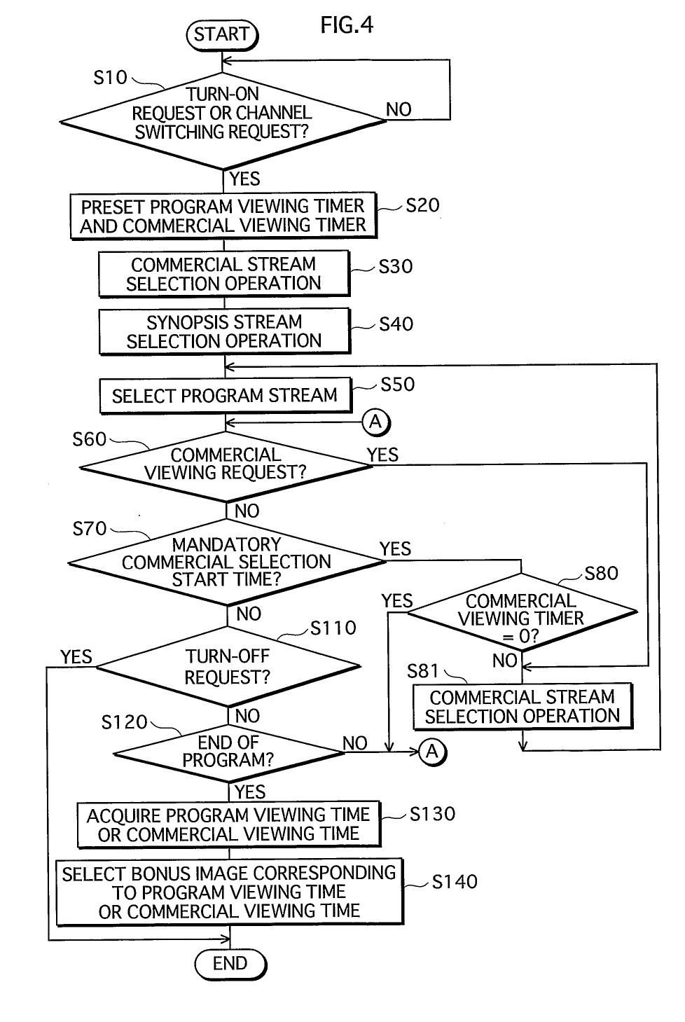

FIG. 4 is a flowchart showing the operation of the reception device. The control unit 107 judges whether or not the user requests any of turn-on of the reception device and channel switching (S10). If the user requests turn-on of the reception device or channel switching, the control unit 107 presets the program viewing timer 111 and the commercial viewing timer 112 (S20). The control unit 107 then performs a commercial stream selection operation (S30). The control unit 107 further performs a synopsis stream selection operation (S40). After this, the control unit 107 selects the program stream (S50). Having selected the program stream, the control unit 107 judges whether the user requests commercial viewing (S60). If the user requests commercial viewing, the control unit 107 performs the commercial stream selection operation (S81). If the user does not request commercial viewing, the control unit 107 judges whether a mandatory commercial selection start time has come (S70). If the mandatory commercial selection start time has come, the control unit 107 judges whether the commercial viewing timer 112 is 0 (S80). If the commercial viewing timer 112 is 0, the control unit 107 proceeds to step S60. If the commercial viewing timer 112 is not 0, the control unit 107 performs the commercial stream selection operation (S81), and then proceeds to step S50. If the mandatory commercial selection start time has not come, the control unit 107 judges whether the user requests turn-off of the reception device (S110). If the user requests turn-off of the reception device, the control unit 107 ends the operation. If the user does not request turn-off of the reception device, the control unit 107 judges whether the program has ended (S120). If the program has not ended, the control unit 107 proceeds to step S60. If the program has ended, the control unit 107 acquires the program viewing time or commercial viewing time of the user (S130). The control unit 107 selects a bonus image corresponding to the program viewing time or commercial viewing time of the user, out of the bonus images included in the streams which make up the broadcast (S140).

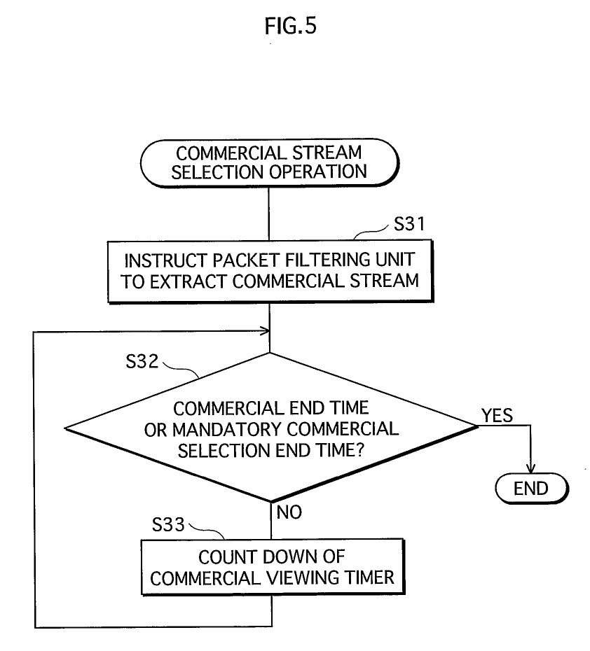

FIG. 5 is a flowchart of the commercial stream selection operation performed in steps S30 and S81 shown in FIG. 4. The control unit 107 instructs the packet filtering unit 102 to extract the commercial stream (S31). The control unit 107 then judges whether or not a corresponding commercial end time or mandatory commercial selection end time has come (S32). If neither the commercial end time nor the mandatory commercial selection end time has come, the control unit 107 decreases the commercial viewing timer 112 (S33). If the commercial end time or the mandatory commercial selection end time has come, the control unit 107 ends the operation.

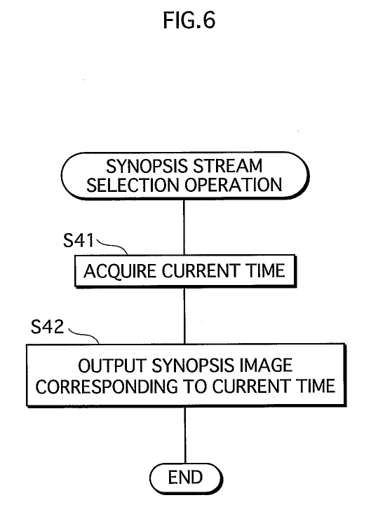

FIG. 6 is a flowchart of the synopsis stream selection operation performed in step S40 shown in FIG. 4. The control unit 107 acquires the current time (S41). The control unit 107 outputs a synopsis image corresponding to the current time, out of the plurality of synopsis images contained in the synopsis stream (S42).

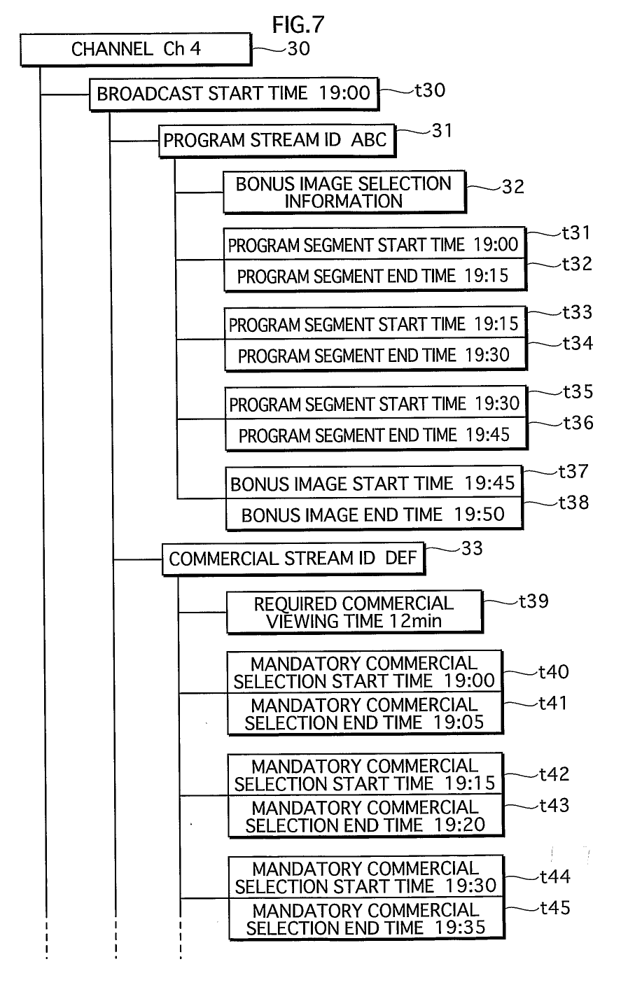

A specific example of the operation of the reception device is explained below, by referring to FIGS. 7 to 10.

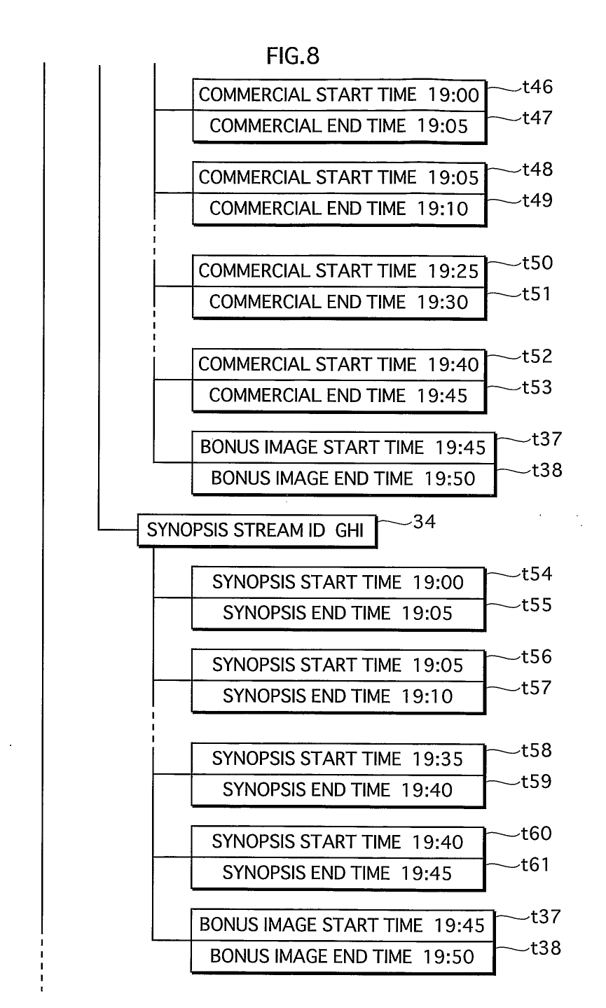

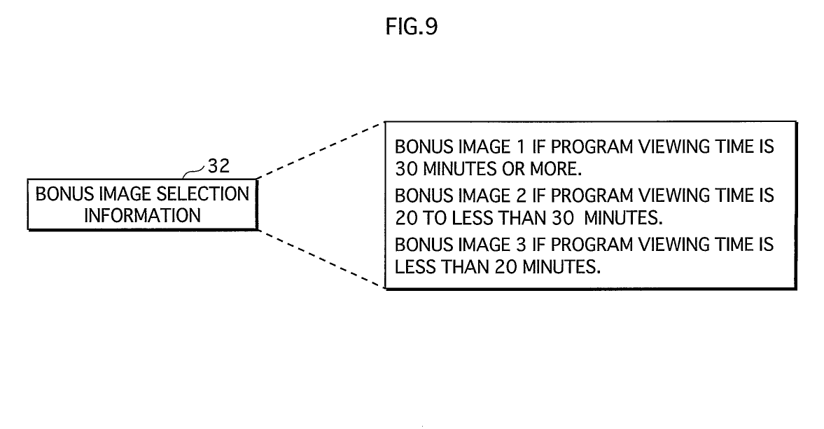

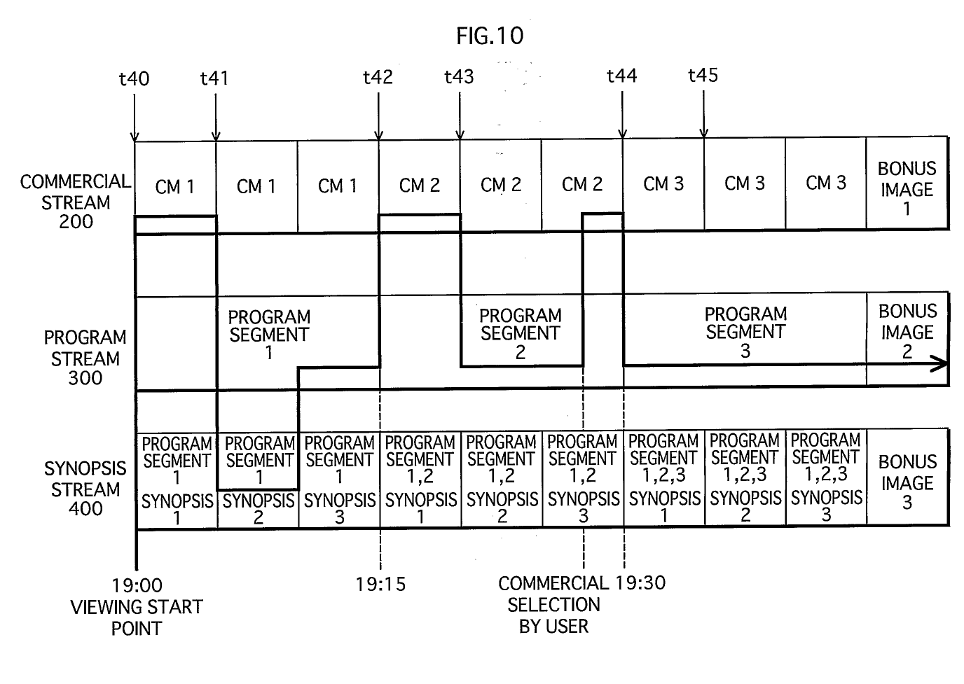

FIGS. 7 and 8 show a specific example of stream switching information. FIG. 9 shows a specific example of bonus image selection information. FIG. 10 shows a specific example of stream selection in the case of FIGS. 7 to 9.

In FIGS. 7 to 9, a channel 30 is Ch4, a broadcast start time t30 is 19:00, and a program stream ID 31 is ABC. Bonus image selection information 32 shows the following criteria for selecting a bonus image, as one example. If the program viewing time is 30 minutes or more, a bonus image 1 is to be selected. If the program viewing time is 20 to less than 30 minutes, a bonus image 2 is to be selected. If the program viewing time is less than 20 minutes, a bonus image 3 is to be selected.

Also, a program segment start time t31 is 19:00, and a program segment end time t32 is 19:15. A program segment start time t33 is 19:15, and a program segment end time t34 is 19:30. A program segment start time t35 is 19:30, and a program segment end time t36 is 19:45. A bonus image start time t37 is 19:45, and a bonus image end time t38 is 19:50.

Meanwhile, a commercial stream ID 33 is DEF, and a required commercial viewing time t39 is 12 minutes. A mandatory commercial selection start time t40 is 19:00, and a mandatory commercial selection end time t41 is 19:05. A mandatory commercial selection start time t42 is 19:15, and a mandatory commercial selection end time t43 is 19:20. A mandatory commercial selection start time t44 is 19:30, and a mandatory commercial selection end time t45 is 19:35. A commercial start time t46 is 19:00, and a commercial end time t47 is 19:05. A commercial start time t48 is 19:05, and a commercial end time t49 is 19:10. A commercial start time t50 is 19:25, and a commercial end time t51 is 19:30. A commercial start time t52 is 19:40, and a commercial end time t53 is 19:45.

Further, a synopsis stream ID 34 is GHI. A synopsis start time t54 is 19:00, and a synopsis end time t55 is 19:05. A synopsis start time t56 is 19:05, and a synopsis end time t57 is 19:10. A synopsis start time t58 is 19:35, and a synopsis end time t59 is 19:40. A synopsis start time t60 is 19:40, and a synopsis end time t61 is 19:45.

In FIG. 10, a program stream 300 is made up of program segments 1, 2, and 3 which constitute a program, and the bonus image 2 that follows the program segment 3. A synopsis stream 400 is made up of a plurality of synopses. In detail, three synopses 1 to 3 which relate to the program segment 1 are arranged in this order, from the program segment start time t31 19:00 to the program segment end time t32 19:15. Each synopsis includes a brief summary of the program segment 1 up to a synopsis end time. Likewise, three synopses 1 to 3 which relate to the program segments 1 and 2 are arranged in this order from the program segment start time t33 19:15 to the program segment end time t34 19:30, and three synopses 1 to 3 which relate to the program segments 1, 2, and 3 are arranged in this order from the program segment start time t35 19:30 to the program segment end time t36 19:45. The bonus image 3 follows these synopses 1 to 3 which relate to the program segments 1 to 3. A commercial stream 200 is made up of a plurality of commercials. In detail, three identical commercials 1 are arranged from the program segment start time t31 19:00 to the program segment end time t32 19:15. Likewise, three identical commercials 2 are arranged from the program segment start time t33 19:15 to the program segment end time t34 19:30, and three identical commercials 3 are arranged from the program segment start time t35 19:30 to the program segment end time t36 19:45. The bonus image 1 follows the commercial 3. In this example, the whole program is 45 minutes long, and one of the bonus images 1 to 3 is selected depending on the program viewing time of the user based on the bonus image selection information 32 shown in FIG. 9. Which is to say, if the program viewing time is no less than 30 minutes, the bonus image 1 is selected. If the program viewing time is no less than 20 minutes but below 30 minutes, the bonus image 2 is selected. If the program viewing time is less than 20 minutes, the bonus image 3 is selected. Here, the bonus image 1 has a higher added value than the bonus image 2, and the bonus image 2 has a higher added value than the bonus image 3. Thus, when the program viewing time is longer, the user can view a higher value-added bonus image.

Suppose the user turns on the reception device at 19:00, to watch the program with the broadcast start time t30 19:00 at the channel 30 Ch4.

When the user requests turn-on of the reception device or channel switching, the commercial stream 200 is mandatorily selected. In this example, the user requests turn-on of the reception device at 19:00, so that the viewing start point is 19:00. The commercial stream 200 is switched to the synopsis stream 400 at a commercial end time corresponding to the viewing start point. In detail, the commercial stream 200 is switched to the synopsis stream 400 at the commercial end time t47 19:05. At this point, the synopsis stream 400 is selected to output a synopsis image corresponding to the current time. In detail, the synopsis 2 which relates to the program segment 1 is output from the synopsis start time t56 19:05 to the synopsis end time t57 19:10. After this, the program stream 300 is selected. At the mandatory commercial selection start time t42 19:15, the commercial stream 200 is mandatorily selected again. At the mandatory commercial selection end time t43 19:20, the program stream 300 is selected again. At about 19:28 during the program segment 2, the user requests commercial viewing. In response, the commercial stream 200 is selected. At the commercial end time t51 19:30, the program stream 300 is selected again. At this point, the required commercial viewing time t39, i.e. 12 minutes, has already been reached. Accordingly, no mandatory selection of the commercial stream 200 is performed at the mandatory commercial selection start time t44 19:30. After the program ends, a bonus image is selected depending on the program viewing time of the user, based on the bonus image selection information 32. Since the program viewing time is about 28 minutes in this example, the bonus image 2 is selected. Hence the program stream 300 is selected after the end of the program segment 3.

According to this embodiment, commercial viewing is promoted by allowing the user to voluntarily request to view a commercial. Even if the user does not voluntarily request commercial viewing, the commercial stream is mandatorily selected when the user turns on the reception device or when the user makes channel switching. Furthermore, the commercial stream is mandatorily selected at each mandatory commercial selection start time. In this way, a sufficient commercial viewing time can be ensured.

### Second Embodiment

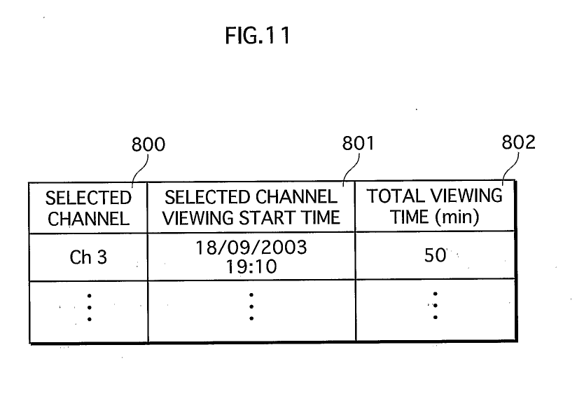

In the first embodiment, the program viewing timer 111 is reset each time channel switching is made. In the second embodiment, the program viewing time is recorded when channel switching is made. To do so, a reception device of the second embodiment stores an internal table about the user's viewing history. FIG. 11 shows an example of such an internal table. In the drawing, the internal table has a selected channel field 800, a selected channel viewing start time field 801, and a total viewing time field 802 for a selected channel. When the user switches to the same channel a plurality of times, each viewing time is accumulated as a total viewing time.

According to this embodiment, even when the user who is viewing one channel switches to another channel for a short time, the program viewing time is not reset but is kept in a record, so that a bonus image is selected according to a total program viewing time.

### Third Embodiment

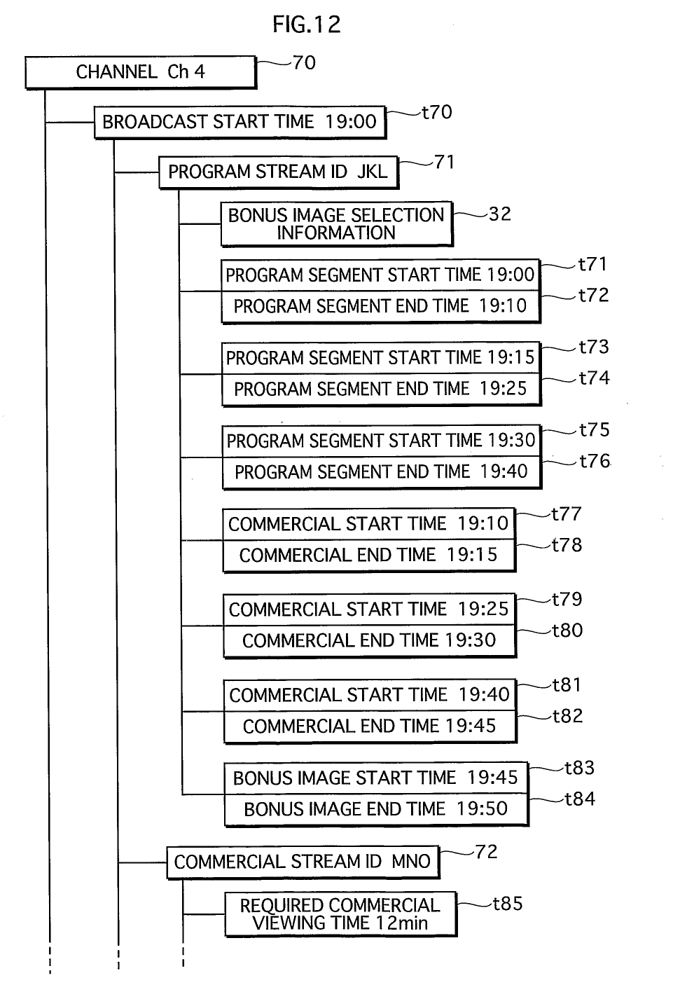

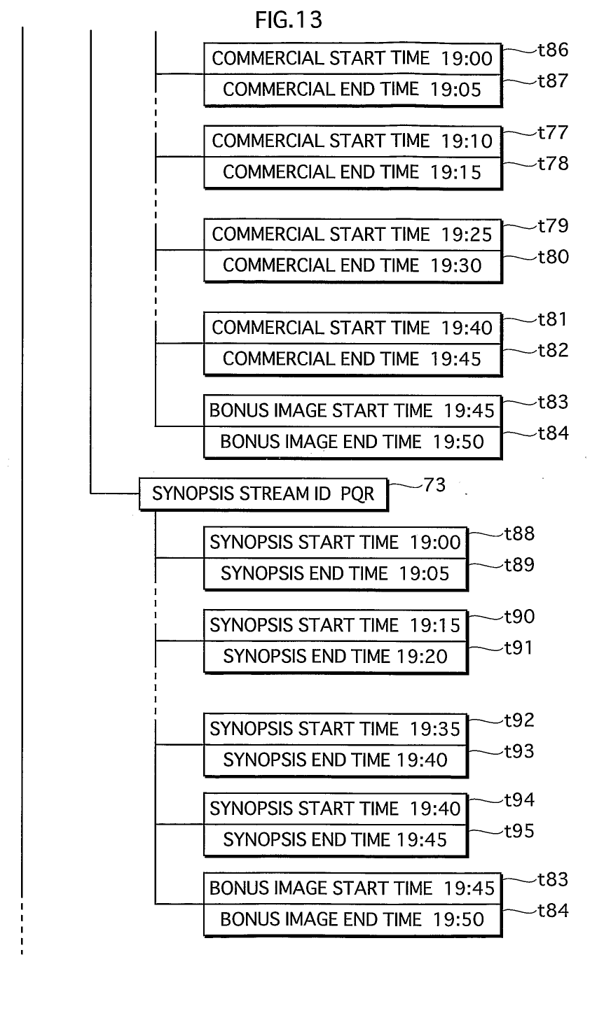

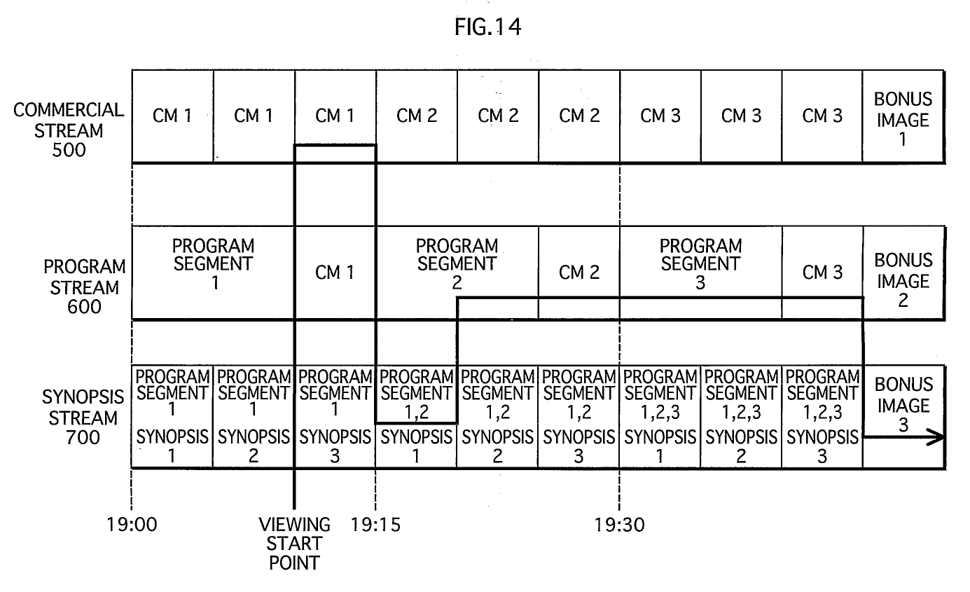

In the first embodiment, a stream which carries only a program is used as a program stream. In the third embodiment, commercials are inserted in a program stream. FIGS. 12 and 13 show a specific example of stream switching information in the third embodiment. FIG. 14 shows a specific example of stream selection in the case of FIGS. 12 and 13. In FIGS. 12 and 13, a channel 70 is Ch4, a broadcast start time t70 is 19:00, and a program stream ID 71 is JKL. The bonus image selection information 32 is the same as the one used in the first embodiment. A program segment start time t71 is 19:00, and a program segment end time t72 is 19:10. A program segment start time t73 is 19:15, and a program segment end time t74 is 19:25. A program segment start time t75 is 19:30, and a program segment end time t76 is 19:40. A commercial start time t77 is 19:10, and a commercial end time t78 is 19:15. A commercial start time t79 is 19:25, and a commercial end time t80 is 19:30. A commercial start time t81 is 19:40, and a commercial end time t82 is 19:45. A bonus image start time t83 is 19:45, and a bonus image end time t84 is 19:50. Meanwhile, a commercial stream ID 72 is MNO, and a required commercial viewing time t85 is 12 minutes. A commercial start time t86 is 19:00, and a commercial end time t87 is 19:05. Further, a synopsis stream ID 73 is PQR. A synopsis start time t88 is 19:00, and a synopsis end time t89 is 19:05. A synopsis start time t90 is 19:15, and a synopsis end time t91 is 19:20. A synopsis start time t92 is 19:35, and a synopsis end time t93 is 19:40. A synopsis start time t94 is 19:40, and a synopsis end time t95 is 19:45.

In FIG. 14, a program stream 600 is made up of the program segment 1, the commercial 1, the program segment 2, the commercial 2, the program segment 3, the commercial 3, and the bonus image 2 in this order. Meanwhile, a commercial stream 500 and a synopsis stream 700 are respectively the same as the commercial stream 200 and the synopsis stream 400 in the first embodiment. Here, selection of a bonus image is performed depending on the program viewing time of the user, as in the first embodiment.

Suppose the user turns on the reception device at 19:10 to watch the program at the channel 70 Ch4.

When the user requests turn-on of the reception device or channel switching, the commercial stream 500 is mandatorily selected. In this example, the user requests turn-on of the reception device at 19:10, so that the viewing start point is 19:10. The commercial stream 500 is switched to the synopsis stream 700 at a commercial end time corresponding to the viewing start point. In detail, the commercial stream 500 is switched to the synopsis stream 700 at the commercial end time t78 19:15. At this point, the synopsis stream 700 is selected to output a synopsis image corresponding to the current time. In detail, the synopsis 1 which relates to the program segments 1 and 2 is output from the synopsis start time t90 19:15 to the synopsis end time t91 19:20. Following this, the program stream 600 is selected. After the end of the program, a bonus image is selected depending on the program viewing time of the user. Since the program viewing time is about 15 minutes in this example, the bonus image 3 is selected. Hence the synopsis stream 700 is selected after the commercial 3 ends.

According to this embodiment, the commercial stream is mandatorily selected immediately after the user starts viewing. Following this, the synopsis stream is selected, and then the program stream is selected until the end of the program. Since the program stream contains commercials, there is no need to switch to the commercial stream. This makes it unnecessary to set a mandatory commercial selection start time and a mandatory commercial selection end time.

### Fourth Embodiment

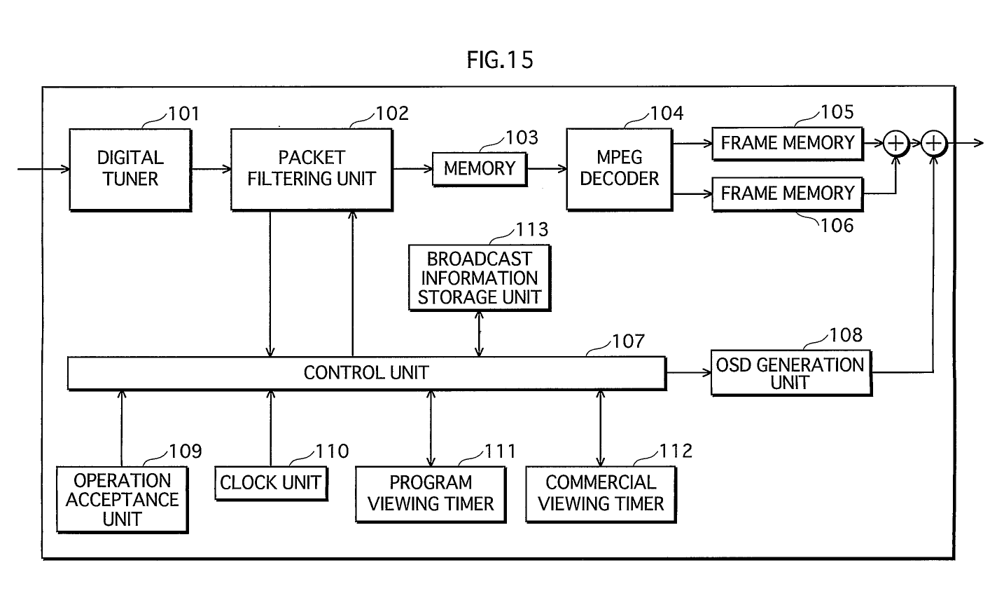

In the first embodiment, the user cannot know which commercial is being broadcast when viewing a program. In the fourth embodiment, a subtitle indicating a commercial which is being broadcast is superimposed on an image of a program, to inform the user of the commercial which is being broadcast. To do so, a reception device of the fourth embodiment includes an OSD (On Screen Display) generation unit 108 for generating a subtitle, as shown in FIG. 15.

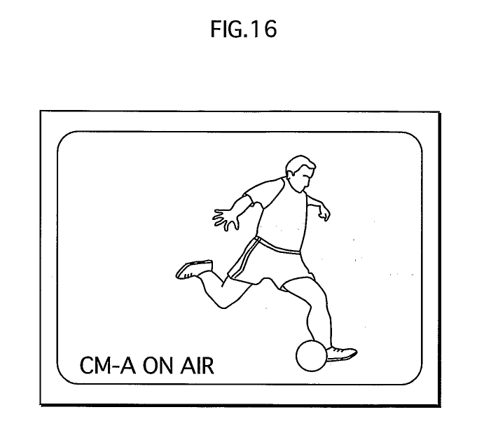

The OSD generation unit 108 generates an OSD. An OSD is simple graphics produced using the colors shown in a LUT (Look Up Table) as background and character colors. In more detail, the OSD generation unit 108 receives subtitle information about a commercial from the control unit 107, and generates a subtitle indicating the commercial. The subtitle generated here is a character string. The generated subtitle is superimposed on a program image output from the MPEG decoder 104. FIG. 16 shows a display screen on which a subtitle indicating a commercial “CM-A” is superimposed on a program image.

The control unit 107 acquires SI, and outputs subtitle information indicating a commercial to the OSD generation unit 108.

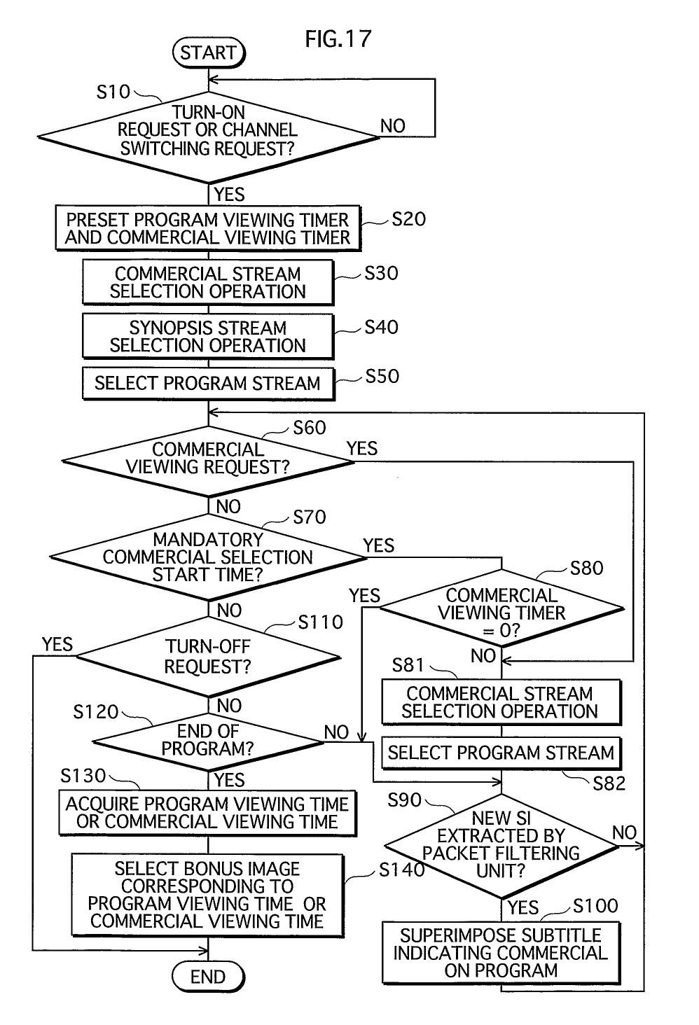

FIG. 17 is a flowchart of an operation of the reception device in the fourth embodiment. The difference from FIG. 4 lies in that steps S82, S90, and S100 have been added. The operation of the reception device in the fourth embodiment is explained below, mainly focusing on the difference from the first embodiment.

The control unit 107 judges whether the commercial viewing timer 112 is 0 (S80). If the commercial viewing timer 112 is 0, the control unit 107 judges whether the packet filtering unit 102 extracts new SI (S90). If the commercial viewing timer 112 is not 0, the control unit 107 performs the commercial stream selection operation (S81). The control unit 107 then selects the program stream (S82), and proceeds to step S90. If the packet filtering unit 102 extracts new SI, the control unit 107 specifies a commercial corresponding to the current time from a plurality of commercials shown in the extracted SI, and has the OSD generation unit 108 display a subtitle indicating the commercial on a program image (S100). If the packet filtering unit 102 does not extract new SI, the control unit 107 proceeds to step S60. Also, the control unit 107 judges whether the program has ended (S120), and proceeds to step S90 if the program has not ended.

According to this embodiment, a subtitle indicating a commercial is overlaid on a program image, to encourage the user to voluntarily request to view the commercial.

### Fifth Embodiment

In the fourth embodiment, a subtitle indicating a commercial is superimposed on a program image, to inform the user which commercial is being broadcast. In the fifth embodiment, when the user selects a commercial stream based on the displayed subtitle, a commercial image is overlaid on a program image as a picture-in-picture. To do so, a reception device of the fifth embodiment includes a frame memory 106, as shown in FIG. 15.

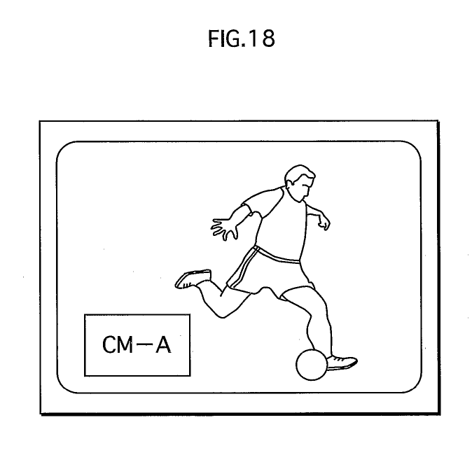

The frame memory 106 is a dedicated memory for storing a commercial image in a small window (a picture-in-picture). FIG. 18 shows a display screen on which the commercial “CM-A” is displayed as a picture-in-picture in response to a user request.

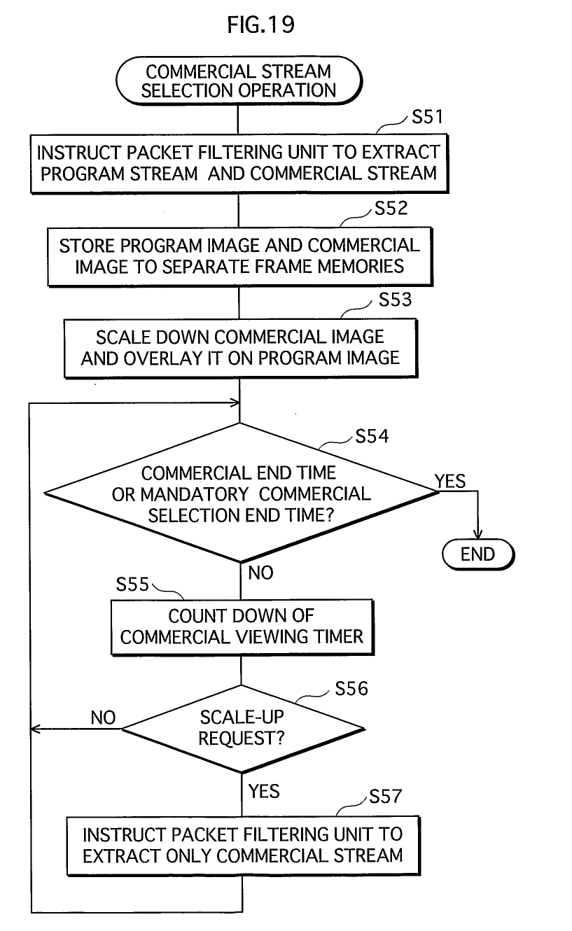

FIG. 19 is a flowchart of a commercial stream selection operation in the fifth embodiment. The control unit 107 instructs the packet filtering unit 102 to extract the program stream and the commercial stream (S51). As a result, a program image and a commercial image are stored respectively in the frame memories 105 and 106 (S52). The commercial image is scaled down into a small window and composited with the program image (S53). The control unit 107 judges whether any of a corresponding commercial end time and mandatory commercial selection end time has come (S54). If so, the control unit 107 ends the operation. Otherwise, the control unit 107 decreases the commercial viewing timer 112 (S55). The control unit 107 judges whether the user requests scale-up of the commercial image (S56). If the user requests scale-up of the commercial image, the control unit 107 instructs the packet filtering unit 102 to extract only the commercial stream (S57). If the user does not request scale-up of the commercial image, the control unit 107 proceeds to step S54.

According to this embodiment, a commercial image can be superimposed on a program image as a picture-in-picture. This enables the user to watch a commercial while watching a program, thereby promoting commercial viewing. If the user becomes interested in the commercial, he or she can enlarge the commercial to watch it in full screen.

### Sixth Embodiment

In the first to fifth embodiments, a channel is constituted by a commercial stream, a program stream, and a synopsis stream. In the sixth embodiment, a channel is constituted by a commercial stream and a program stream without a synopsis stream.

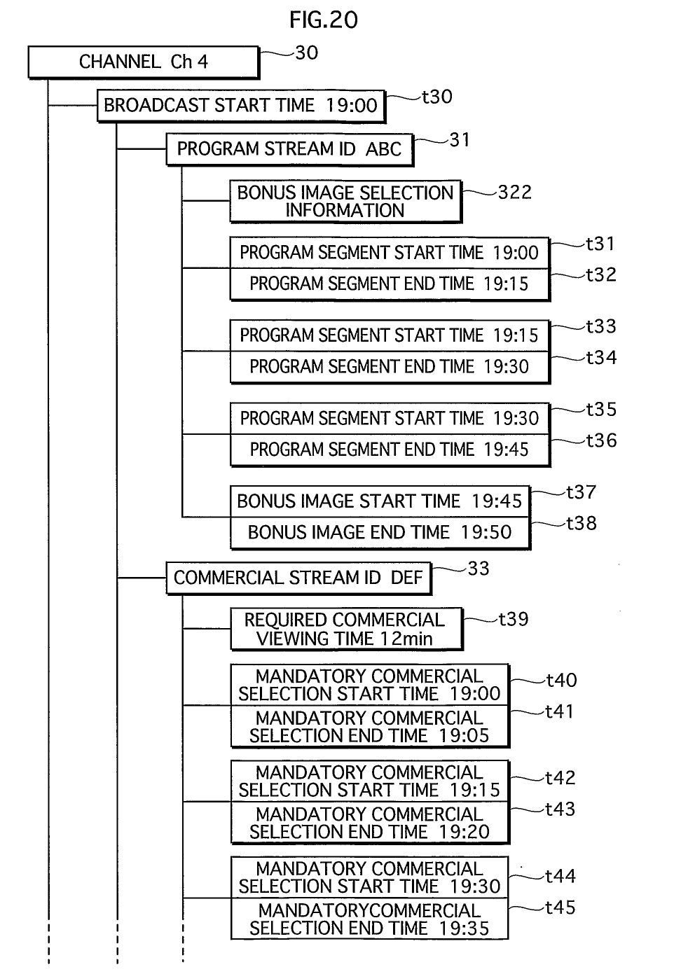

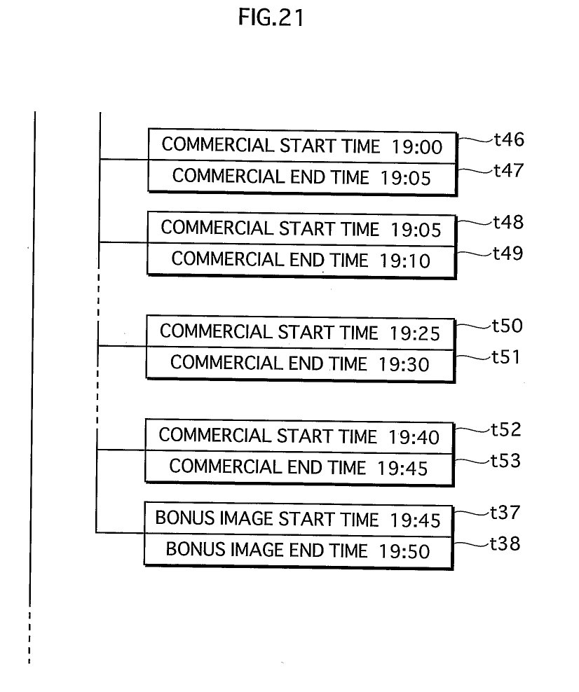

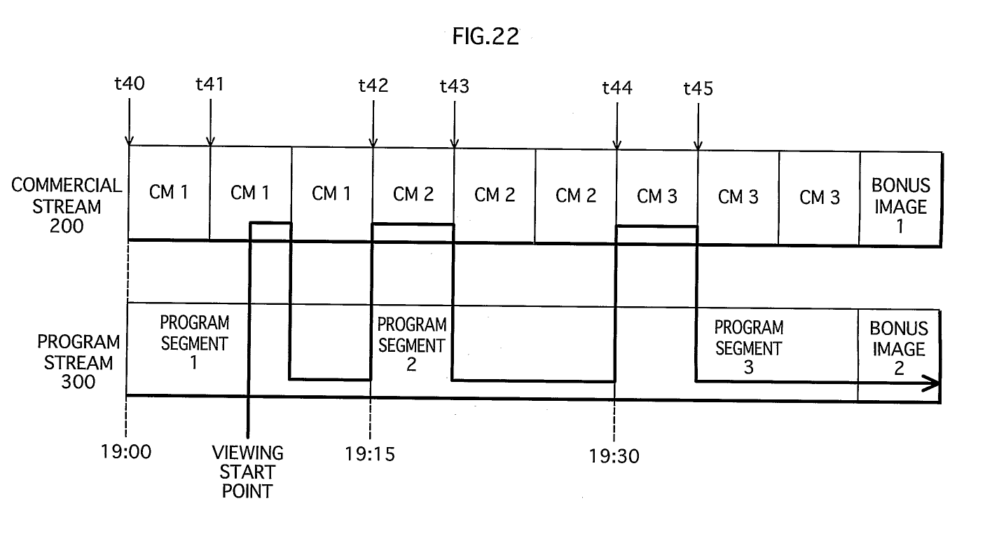

FIGS. 20 and 21 show a specific example of stream switching information in the sixth embodiment, and FIG. 22 shows a specific example of stream selection in the case of FIGS. 20 and 21. FIGS. 20 and 21 differ from FIGS. 7 and 8 in that the information about the synopsis stream is omitted. Bonus image selection information 322 has the same contents as the one shown in FIG. 9, except that the information about the bonus image 3 included in the synopsis stream is omitted. Here, selection of a bonus image is performed depending on the program viewing time of the user, as in the first embodiment.

Suppose the user switches to the channel 30 Ch4 at 19:08.

When the user requests turn-on of the reception device or channel switching, the commercial stream 200 is mandatorily selected. In this example, the user makes channel switching at 19:08, so that the viewing start point is 19:08. This being so, the commercial stream 200 is switched to the program stream 300 at the corresponding commercial end time t49 19:10. At the mandatory commercial selection start time t42 19:15, the commercial stream 200 is mandatorily selected again. At the mandatory commercial selection end time t43 19:20, the program stream 300 is selected again. At the mandatory commercial selection start time t44 19:30, the commercial stream 200 is mandatorily selected again. At the mandatory commercial selection end time t45 19:35, the program stream 300 is selected again. After the program ends, a bonus image is selected depending on the program viewing time of the user. In this example, the program viewing time is about 25 minutes, so that the bonus image 2 is selected. Hence the program stream 300 is selected after the end of the program segment 3.

### Seventh Embodiment

In the first to sixth embodiments, a commercial stream is switched to a synopsis stream or a program stream at a commercial end time. In the seventh embodiment, a commercial stream is switched to a synopsis stream or a program stream using a timer. For example, when one duration in which the commercial stream is continuously selected reaches a duration T, the commercial stream is switched to another stream according to the timer. This duration T is shown in stream switching information, which is transmitted to the reception device via a stream. This being so, the broadcast information storage unit 113 records the duration T as the duration in which the commercial stream is to be continuously selected. In this case, there is no need to set a mandatory commercial selection end time.

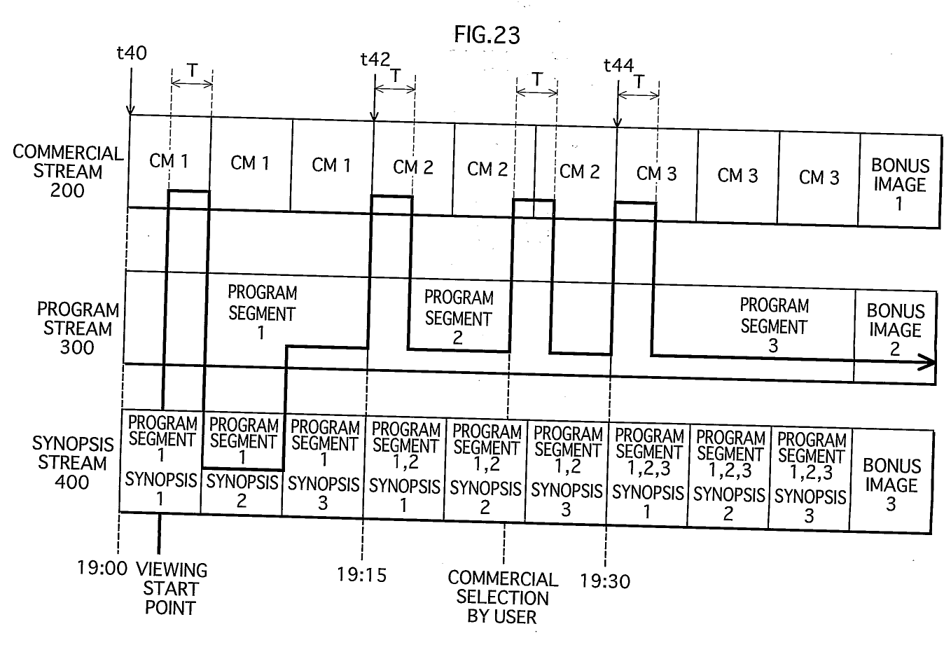

FIG. 23 shows a specific example of stream selection in the seventh embodiment. This stream selection is explained below, with reference to FIGS. 7 to 9. It is assumed here that the mandatory commercial selection end times are omitted and instead the duration T is included in the stream switching information shown in FIGS. 7 and 8. In this example, the duration T is 3 minutes. Selection of a bonus image is performed according to the program viewing time of the user, as in the first embodiment.

Suppose the user turns on the reception device at 19:02.

When the user requests turn-on of the reception device or channel switching, the commercial stream 200 is mandatorily selected. In this example, the user turns on the reception device at 19:02, so that the viewing start point is 19:02. The commercial stream 200 is selected for 3 minutes from the viewing start point. In detail, the commercial stream 200 is selected from 19:02 to 19:05. Following this, the synopsis stream 400 is selected to output a synopsis image corresponding to the current time. In detail, the synopsis 2 which relates to the program segment 1 is output from the synopsis start time t56 19:05 to the synopsis end time t57 19:10. After this, the program stream 300 is selected. At the mandatory commercial selection start time t42 19:15, the commercial stream 200 is mandatorily selected. At 19:18, the program stream 300 is selected again. At about 19:23 during the program segment 2, the user requests commercial viewing. In response to this, the commercial stream 200 is selected. At 19:26, the program stream 300 is selected again. At the mandatory commercial selection start time t44 19:30, the commercial stream 200 is mandatorily selected. At 19:33, the program stream 300 is selected again. After the program ends, a bonus image is selected depending on the program viewing time of the user, based on the bonus image selection information 32. In this example, the program viewing time is about 26 minutes, so that the bonus image 2 is selected. Hence the program stream 300 is selected after the end of the program segment 3.

According to this embodiment, the commercial stream is switched to the synopsis stream or the program stream using a timer. In the case where the commercial stream is selected from the viewing start point to a corresponding commercial end time, a time during which the commercial stream is continuously selected may end up being very short depending on the viewing start point. In this embodiment, on the other hand, it is possible to ensure commercial viewing for the duration T before the start of program viewing, irrespective of the viewing start point.

(Modifications)

Although the present invention has been described by way of the above embodiments, it should be obvious that the present invention is not limited to the above. Example modifications are given below.

(1) The above embodiments are intended to ensure a sufficient commercial viewing time. Therefore, the commercial stream is selected even at a midpoint in a commercial. Alternatively, the reception device may perform buffering, to enable the user to view from the beginning of the commercial.

(2) In the above embodiments, when the program stream is switched to the commercial stream and then the commercial stream is switched back to the program stream, the program has advanced by the time during which the commercial stream is selected. As an alternative, the reception device may perform buffering, to enable the user to view the program at the point where the program stream is switched to the commercial stream. Suppose the commercial stream is selected between innings in a baseball broadcast. In this case, the user experiences no inconvenience even if the program has advanced by the time during which the commercial stream is selected. In the case of a movie or the like, however, it is preferable to perform buffering so that the user can view the whole program.

(3) The above embodiments describe the case where a bonus image is included at the end of each stream which belongs to one channel. Instead, a plurality of bonus images may be included at the end of the program stream.

(4) The above embodiments describe the case where the required commercial viewing time is shown in stream switching information which is transmitted to the reception device via a stream, but the required commercial viewing time may be recorded in the reception device beforehand.

(5) The above embodiments describe the case where when the user requests commercial viewing, the commercial stream is selected until a corresponding commercial end time. Alternatively, the commercial stream may be selected until the user requests program viewing.

(6) The above embodiments describe the case where n pairs of commercial start and end times and n pairs of synopsis start and end times are included in stream switching information, though they need not be the same in number.

(7) The above embodiments describe the case where the commercial stream is mandatorily selected at regular intervals, but the mandatory selection of the commercial stream need not be made at regular intervals. As one example, the commercial stream may be mandatorily selected all at once at the end of the program.

(8) The above embodiments describe an example where the selection of a bonus image is made depending on the program viewing time of the user, but the selection may instead be made depending on the commercial viewing time of the user.

(9) The present invention can be realized by a method that includes the steps shown in each of the above flowcharts. The present invention can also be realized by a computer-readable program that includes program code which causes a computer to perform the steps shown in each of the above flowcharts. The present invention can further be realized by a system integrated circuit that achieves the above method.

### INDUSTRIAL APPLICABILITY

The internal construction of the reception device to which the present invention relates is disclosed in the above embodiments. The reception device can be manufactured in quantity based on the disclosed internal construction. Accordingly, the reception device can be utilized industrially. Hence the present invention possesses industrial applicability.

1. A reception device for receiving a broadcast wave, selecting any of a commercial stream and a program stream that are modulated in the broadcast wave, and outputting the selected stream, comprising:
an acceptance unit operable to accept a channel operation by a user; and
a switch unit operable to, when the acceptance unit accepts the channel operation, select the commercial stream before the program stream, as the stream to be output.

2. The reception device of claim 1, further comprising
a first judgment unit operable to judge whether an end time of one of a plurality of commercials which are included in the commercial stream has come, the commercial stream also including time information showing an end time of each of the plurality of commercials,
wherein the switch unit switches from the commercial stream to the program stream when the first judgment unit judges that the end time of the commercial has come.

3. The reception device of claim 2, further comprising
a second judgment unit operable to judge whether an end time of one of a plurality of program segments which are included in the program stream has come, the program stream also including time information showing an end time of each of the plurality of program segments,
wherein the switch unit switches from the program stream back to the commercial stream when the second judgment unit judges that the end time of the program segment has come.

4. The reception device of claim 3,
wherein the switch unit repeatedly switches from the commercial stream to the program stream and back to the commercial stream, so long as a predetermined condition is met.

5. The reception device of claim 4, further comprising
a measurement unit operable to measure a total time during which the commercial stream is selected,
wherein the predetermined condition is that the total time is below a required commercial viewing time.

6. The reception device of claim 3, further comprising
a third judgment unit operable to judge whether the acceptance unit accepts a commercial viewing operation by the user before the end time of the program segment,
wherein when the third judgment unit judges that the acceptance unit accepts the commercial viewing operation before the end time of the program segment, the switch unit switches from the program stream back to the commercial stream without waiting for the end time of the program segment.

7. The reception device of claim 6, further comprising
a display unit operable to display a character string indicating one of the plurality of commercials that corresponds to a current time,
wherein the acceptance unit accepts the commercial viewing operation of requesting to view the commercial indicated by the displayed character string.

8. The reception device of claim 1,
wherein a synopsis stream is modulated in the broadcast wave together with the commercial stream and the program stream, and
the switch unit selects the synopsis stream after the commercial stream and before the program stream, for a predetermined time period.

9. The reception device of claim 8,
wherein the synopsis stream includes a plurality of synopses, and
the switch unit selects the synopsis stream to output one of the plurality of synopses that corresponds to a current time.

10. The reception device of claim 7, further comprising
a composite unit operable to, when the switch unit switches from the program stream back to the commercial stream, display a composite image in which an image of the commercial indicated by the displayed character string is scaled down and superimposed on an image of the program segment.

11. The reception device of claim 1,
wherein each of the program stream and the commercial stream includes a bonus image at an end portion, and any of the program stream and the commercial stream includes information showing a selection criterion for each bonus image,
the reception device further comprises:
a measurement unit operable to measure a total time during which one of the program stream and the commercial stream is selected; and
an output unit operable to, when a current time reaches the end portion of the program stream, output a bonus image corresponding to a selection criterion that is satisfied by the total time measured by the measurement unit.

12. A computer-readable program used in a computer for receiving a broadcast wave, selecting any of a commercial stream and a program stream that are modulated in the broadcast wave, and outputting the selected stream, comprising:
program code operable to cause the computer to accept a channel operation by a user; and
program code operable to cause the computer to, when the channel operation is accepted, select the commercial stream before the program stream, as the stream to be output.

13. A reception method for receiving a broadcast wave, selecting any of a commercial stream and a program stream that are modulated in the broadcast wave, and outputting the selected stream, comprising steps of:
accepting a channel operation by a user; and
selecting, when the channel operation is accepted, the commercial stream before the program stream, as the stream to be output.

14. A system integrated circuit for use in a reception device for receiving a broadcast wave, selecting any of a commercial stream and a program stream that are modulated in the broadcast wave, and outputting the selected stream, comprising:
an acceptance unit operable to accept a channel operation by a user; and
a switch unit operable to, when the acceptance unit accepts the channel operation, select the commercial stream before the program stream, as the stream to be output.
